(19) United States
(12) Patent Application Publication
(10) Pub. No.: US 2010/0156700 A1
(43) Pub. Date: Jun. 24, 2010

(54) METHOD OF MANAGING THE FREQUENCIES AND BORESIGHTINGS EMITTED BY A DISPERSIVE-ANTENNA RADAR

(75) Inventors: Frederic Barbaresco, Montgeron (FR); Jean-Claude Deltour, Fresnes (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/641,881

(22) Filed: Dec. 18, 2009

(30) Foreign Application Priority Data
Dec. 19, 2008 (FR) 0807213

(51) Int. Cl. G01S 13/00

(52) U.S. Cl. 342/81

(57) ABSTRACT

The present invention pertains to methods for managing resources in radar time, that is to say methods making it possible to manage in an optimal manner the scheduling of the boresightings performed.

The method according to the invention firstly consists in supplying a table containing candidate boresightings. These candidate boresightings are those corresponding to the boresighting requests to be taken into account by the radar. Each boresighting is associated with a set of candidate frequencies, chosen from among the set of authorized frequencies, each set being defined specifically for each candidate boresighting. The candidate frequencies are determined so as to guarantee a diversity of the frequencies which are emitted by the radar, all boresightings taken together. The management of the boresighting requests takes into account in a dynamic manner the variations in the rotation speed of the antenna.

The method thereafter consists in selecting from the table, through various steps, a candidate boresighting and for this selected boresighting, one of the candidate frequencies with which it is associated. This selected (boresighting, frequency) pair is transmitted to the means charged with undertaking the emission of the corresponding wave.

The invention applies in particular to the management of the boresightings by a surveillance radar with dispersive slot antenna.

### CROSS REFERENCE TO RELATED APPLICATIONS

The present application claims priority to French Patent Application Serial No. 0807213, filed Dec. 19, 2008, which is hereby incorporated by reference in its entirety.

### FIELD OF THE INVENTION

The present invention relates to the general field of systems for managing multifunction electronic scan radars. It pertains to methods for managing resources in radar time, that is to say methods making it possible to manage in an optimal manner the scheduling of the boresightings performed. The term boresighting is intended to mean the utilization, for the implementation of one and the same function, of the signals obtained by emitting a given waveform in a direction in space given by the antenna pattern. The invention applies in particular to the management of the boresightings by a surveillance radar with dispersive slot antenna.

### BACKGROUND OF THE INVENTION

The phenomenon of dispersive aperture is a phenomenon which affects certain radars (slot antenna radars). It is manifested notably in a known manner as a deterministic off-boresighting of the antenna beam as a function of frequency. These radars are generally monofunction surveillance radars whose production cost is relatively low.

For such radars, this phenomenon, which affects the direction of boresighting of the beam, is very generally considered to be a drawback which needs to be corrected in real time. Accordingly, for example, the azimuthal deviation caused is conventionally taken into account in the management of boresightings in such a way that, having regard to this deviation, the required waveform is emitted in the desired direction.

In the case of a conventional surveillance radar and in particular in the case of a dispersive-antenna surveillance radar, the simplicity of the manner of operation implemented entails a fixed and deterministic definition of the scheduling of the boresightings and of the frequencies in the course of the space scan by the antenna. This scheduling is pre-established in advance for various frequency plans (authorized and/or unjammed frequencies). It is generally stored in a table which is read in a periodic manner with a constant periodicity which corresponds to the theoretical rotation speed of the antenna. In this way, for a given boresighted direction, the antenna being considered to have a determined and constant rotation speed, the waveform played is known in a deterministic manner from one revolution to another.

In this type of radar, the proper management of the boresightings is therefore generally dependent on the precision and stability of the rotation speed of the antenna. Thus if the real rotation speed of the antenna is not equal to the theoretical speed, the position of the antenna at a given instant is different from that required. Moreover the existence of a fluctuation in the rotation speed over the antenna revolution results in an uncontrolled fluctuation of the value of the azimuthal offset between adjacent beams, which fluctuation may not be regulated by the means charged with managing the radar time resources.

### SUMMARY OF THE INVENTION

An aim of the invention is to exploit the dispersivity phenomenon so as to expand the operational capabilities of a dispersive-antenna surveillance radar by rendering it capable of operating to a certain extent in the manner of a multifunction radar while ensuring the diversity of the frequencies played (the equiprobability and the non-predictability of the frequencies used according to the authorized frequency plans), the regulation of the load (relating to the current radar time budget and the variation in speed of the antenna) and the robustness of the radar to jamming (robustness in relation to the instantaneous listening to the jammed frequencies and the information kept revolution by revolution on the jammed frequency maps). Another aim of the invention, relating to the management of the radar time budget, is to maintain the rate of operational use of the radar, by regulating, and no longer by suffering, the variations in the instantaneous offset between the contiguous boresightings when the antenna period is not at its nominal value (rotation of the antenna slower or faster on average) and when the antenna rotation speed fluctuates fairly greatly within the revolution.

For this purpose the subject of the invention is a method for managing the emission of the boresightings by a radar comprising a dispersive antenna whose speed may vary in the course of time, the management being performed as a function of the angle of rotation of the antenna, the method being applied to candidate boresightings, each candidate boresighting being associated in a table with one or more candidate frequencies, characterized in that it comprises the following steps:
a step of selecting the required boresightings whose direction is visible at the instant considered;
a step of selection by the authorized frequencies;
a step of selecting the least jammed eligible frequencies;
a step of selecting the least used eligible frequencies;
a step of creating new boresighting requests;
   the steps of the method forming a sequentially repeated cycle, the table which associates the candidate boresightings and the candidate frequencies being updated at each cycle.

In a preferred mode of implementation, the method according to the invention furthermore comprises a final complementary step for treating the case of the boresightings which are no longer visible on completion of the current iteration having regard to the direction of the antenna.

In a particular mode of implementation, the method according to the invention furthermore comprises a first intermediate step which consists in discarding from the selection the candidate boresightings which, if they were ultimately selected during the iteration considered, could induce the loss of one or more other candidate boresightings whose duration of visibility is short. This first intermediate step is placed after the first main step.

In a particular mode of implementation, that can be combined with the previous mode, the method according to the invention furthermore comprises a second intermediate step for performing the selection of the boresightings declared as having the highest priority. This second intermediate step is placed after the second main step.

In a preferred mode of implementation of the method according to the invention, the step of creating new boresighting requests undertakes for each candidate boresighting the association of a frequency span included in an interval bounded by two frequencies fₘᵢₙ and fₘₐₓ. The frequency fₘₐₓ is the highest frequency of the domain of frequencies actually allocated to the radar. The frequency fₘᵢₙ is a frequency chosen in a random manner in a frequency domain extending from the lowest frequency of the authorized frequency plan, to a frequency fₗᵢₘᵢₜ_{_{—}}_{draw} greater than fₘᵢₙ and less than fₘₐₓ.

In this preferred mode of implementation, the frequency fₘᵢₙ can be obtained by a random draw which follows a law of decreasing probability density as the frequency increases.

In this preferred mode of implementation, the frequency fₗᵢₘᵢₜ_{_{—}}_{draw} can be determined so as to define with fₘₐₓ an interval of frequencies containing a number n of authorized frequencies that is small relative to the number of authorized frequencies.

In a preferred mode of implementation of the method according to the invention, the step of creating new boresighting requests takes into account, for the determination of the new candidate boresightings, a first angular window contiguous with the visibility domain for the determination of the new surveillance boresightings and a second angular window contiguous with the first window for the determination of the other new boresightings. The angular windows are determined so as to take into account the antenna rotation period and the mean duration of the boresightings.

In this preferred mode of implementation, the first angular window is determined so as to correspond to the angle of rotation of the antenna over a duration equivalent to the maximum duration of a half-boresighting, to which is added the maximum delay that can exist between the moment at which a boresighting has been selected and the moment at which it is actually emitted. The size of the second angular window is for its part defined as being proportional to the azimuthal extension value DAz_{LoadAdaptation} which corresponds to a multiple of the azimuthal extension corresponding to the partial visibility domain, DAz_{LoadAdaptation} being in all cases less than the complete visibility domain.

In a preferred mode of implementation of the method according to the invention, the step of selecting the least jammed eligible frequencies takes into account the information relating to the least jammed frequencies for the selection of the boresightings in two possible ways, either locally by instantaneous listening to the jammed frequencies or globally by the use of the maps of jammed frequencies available.

Advantageously, the method according to the invention makes it possible to order, on a dispersive antenna, broadband boresightings termed “Recognition of non-cooperative targets” by the optimized sequencing of a series of successive narrowband boresightings. Each narrowband boresighting is played successively over time towards the target, by using the antenna rotation to play the narrowband emissions one after another.

Advantageously also, the method according to the invention allows the insertion of addressed boresightings, tracking boresightings for example, in the general sequencing of the boresightings, doing so in a manner similar to a two-plane multifunction electronic scan radar.

### BRIEF DESCRIPTION OF THE DRAWINGS

The characteristics and advantages of the invention will be better appreciated by virtue of the description which follows, which description sets forth the invention through a particular embodiment taken as non-limiting example and which is supported by the appended figures, which figures represent:

FIGS. 1 and 2, illustrations of the problem posed in the management of the boresightings by the presence of uncontrolled temporal fluctuations of the antenna rotation speed;

FIG. 3, an illustration of the parameters describing the dispersivity phenomenon;

FIG. 4, an illustration of the principle for utilizing the dispersivity phenomenon by the method according to the invention;

FIG. 5, a basic flowchart of the various steps of the method for planning the boresightings according to the invention;

FIG. 6, illustrations of various examples of distribution of the operating frequency plans of a radar as well as of the parameters for managing the frequencies associated with a boresighting;

FIG. 7, an illustration of the manner in which the lower bound of the window of the operating frequencies, the use of which is authorized and which is allotted to each boresighting, is randomly drawn;

FIG. 8, an illustration of the principle for selecting the boresightings on the basis of their managed visibility domain and the current position of the antenna in terms of azimuth;

FIG. 9, an illustration of the scheme for limiting the number of boresightings liable not to be executed on account of the expiry of the time intervals during which they are executable;

FIG. 10, the illustration of the manner in which the third step of the method according to the invention takes into account the discrete nature of the operating frequencies and performs the selection of the candidate discrete frequencies which are compatible with the theoretical frequency corresponding to the direction of the boresighting considered;

FIG. 11, the illustrations of the various principles for selecting a frequency that can be implemented by the sixth step of the method according to the invention, when several frequencies are still candidates at this stage;

FIG. 12, the illustration of the principle of updating the table of the candidate boresightings implemented in the course of the seventh step of the method according to the invention.

FIG. 13, the illustration of the principle of managing the dead times (instant for which no boresighting is playable or can be played) by the insertion of technical boresightings of determined duration;

FIG. 14, an illustration of the effects caused by an antenna rotation speed differing from the expected nominal value and by fluctuations of this rotation speed.

### DETAILED DESCRIPTION

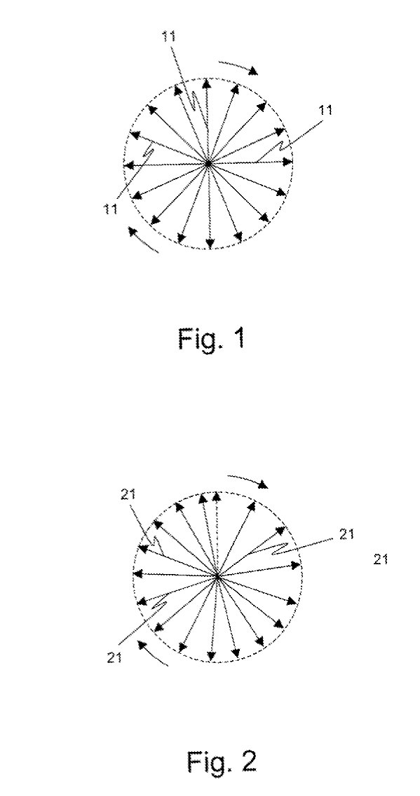

FIGS. 1 and 2 illustrate in a schematic manner the effect of the variations in the antenna rotation speed on the quality of the coverage achieved by a surveillance radar whose boresightings management system does not take these variations into account.

FIG. 1 corresponds to the theoretical case in which the antenna of the radar rotates at a precisely known constant speed ω₀. In this circumstance, it is possible to control in a deterministic manner the instant t at which the lobe of the antenna is directed in a given direction θ. Accordingly, it is possible to implement a surveillance operating mode in which space is regularly explored, the directions boresighted, demarcated by the arrows 11 in FIG. 1, being regularly spaced and precisely determined.

FIG. 2, for its part, presents the case of an antenna for which the rotation speed is not perfectly regulated. In such a case under certain atmospheric conditions (gusting winds) the nominal rotation speed ω₁ of the antenna is not strictly equal to the theoretical rotation speed ω₀. Furthermore, the rotation speed ω₁ is not constant in the course of time so that the real antenna rotation speed can be written:

ω₁=ω₀+Δω+δω(t) [1]

where Δω represents a constant bias with respect to the theoretical rotation speed ω₀ and where δω(t) represents a term of fluctuation around the biased speed which varies as a function of time, that is to say as a function of the direction towards which the antenna lobe is oriented.

This uncontrolled variation in the rotation speed may result in an irregular distribution of the boresightings carried out which is not controlled by the management of the beams, demarcated by the arrows 21 in FIG. 2, although the boresightings are, as in the case of FIG. 1, regularly instructed in the course of time. The consequence of such a variation in the rotation speed of the antenna is notably that the angular offset between boresightings is not regulated. Thus, on account of a rigid sequencing initially defined for a constant rotation speed, frequencies which are unauthorized in a given direction may for example be used. This irregular distribution of the boresightings carried out may cause local overloads of the sequencing of the radar boresightings to be executed, overloads that conventional radars, of the dispersive antenna type, cannot absorb.

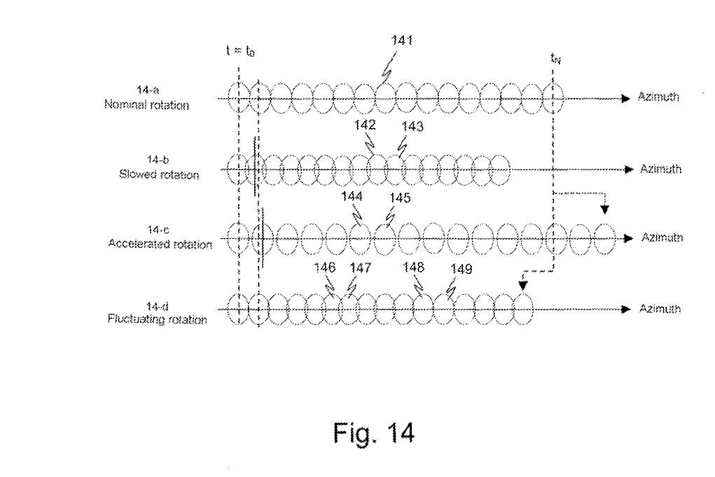

A consequence, as illustrated by FIG. 14, of the variation in the antenna rotation speed, which is manifested as a bias in this speed and as a fluctuation around this bias, is that the boresightings 141 are more or less angularly offset.

The illustration 14-a corresponds to a nominal speed with an offset between boresightings which corresponds exactly to the attenuation value at 3 dB of the corresponding beams (the curves depicting the width of the beam at −3 dB are then tangential to the joining point).

The illustration 14-b corresponds, for its part, to a lower speed for which the inter-beam spacing of consecutive boresightings 142 and 143 is systematically tightened and the beams are superimposed in the zones corresponding to the 3-dB lobe widths.

The illustration 14-c corresponds, for its part, to a higher speed for which the beams of consecutive boresightings 144 and 145 are systematically disjoint.

Finally, the illustration 14-d corresponds to a situation of fluctuation of the speed around a nominal speed, a situation for which the offset between the beams of consecutive boresightings, 146 and 147 or 148 and 149, evolves from boresighting to boresighting.

Accordingly, if it is desired to control or at least regulate the positions of the directions actually boresighted in an instantaneous manner, by taking account of the authorized frequencies, it is necessary to put in place means allowing the best possible compensation for this phenomenon of fluctuation of the rotation speed of the antenna. The method according to the invention advantageously constitutes such a means.

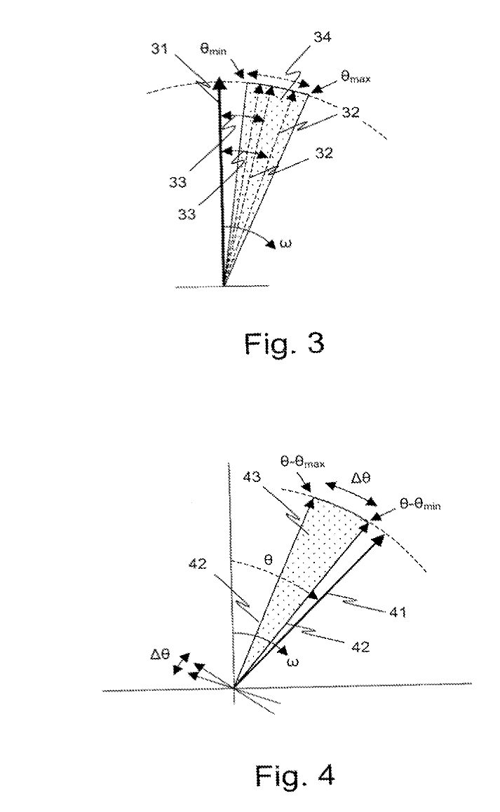

As was stated previously, the operating principle of the method according to the invention relies on the use of the azimuthal dispersivity phenomenon caused to the emission (and reception) pattern of an antenna, of slotted antenna type for example, by the variation in frequency of the radar equipped with such an antenna. FIG. 3 illustrates this phenomenon which is manifested by the fact that, as a function of the emission frequency, such as an antenna's radiation pattern, depicted by the dashed arrows 32 in the figure, exhibits an angular shift 33 with respect to the antenna direction 31, the value of which shift is dependent on the emission frequency. Here, the expression antenna direction is understood to mean the axis perpendicular to the plane of the antenna.

This angular shift lies in a sector 34 defined by the span of the operating frequencies of the radar. The sector 34 depends on the frequency band Δf used by the radar and depends on the minimum and maximum frequencies that can be used in the band Δf. In the example of FIG. 3, the sector 34 is presented as being shifted as a lead with respect to the axis of the antenna 31. However, the sector 34 can be shifted as a delay with respect to the axis of the antenna 31. It can also be positioned on either side of the axis of the antenna 31 and in this case, for a slot antenna, physical constraints mean that the sector 34 is defined as two sub-sectors, right and left, separated by an unauthorized intermediate sector.

Conversely, by taking a boresighted direction as angular reference, it is noted, as illustrated by FIG. 4, that for a given direction θ 41 and a given emission frequency band Δf, it is possible to define an angular sector 43, of width Δθ=[θ−θₘᵢₙ θ−θₘₐₓ], such that, having regard to the rotation ω of the antenna, it is always possible by making use of the emission frequency to deflect the beam of the antenna in the direction 6 while the antenna direction 42 scans this sector. Accordingly, it is noted that for a given direction θ 41, a boresighting can be executed in this direction, by profiting from the deflection due to the presence of dispersivity, as soon as and as long as the direction of the antenna 42 is present during the antenna rotation in the angular interval Δθ=[θ−θₘᵢₙ θ−θₘₐₓ].

The method according to the invention puts this principle into practice so as to render a monofunction radar capable of operating, to a certain extent, like a multifunction radar. The limitations of this ability are notably tied to the maximum and minimum deflections that can be achieved using the dispersivity and to the minimum and maximum operating frequencies that can be used. The method according to the invention also puts this principle into practice so as to compensate at least in part for the variations in the antenna rotation speed.

With this aim, its main function is to temporally sequence the order in which various waveforms can be implemented, in the course of the rotation of the antenna, each waveform having to be applied for a given boresighting direction and in a given time span, knowing that a consequent number of orderings of the boresightings is possible because the choice at a given instant of a given operating frequency makes it possible to execute one boresighting rather than another. Accordingly the ordering is carried out by taking account, among other things, of the maximum duration during which the beam of the antenna can be boresighted in a given direction having regard to the instantaneous rotation speed of the antenna and the value of the angular sector Δθ, knowing that other boresightings have to be carried out in this same time interval.

Generally, the waveform having to be implemented in a spatial direction covered by the radar is determined by the function (surveillance function or other addressed functions, such as for example a tracking function) that must be implemented by the radar in this direction. One speaks in a known manner of boresighting, a boresighting corresponding to the use of a given waveform to illuminate in a manner specific to the boresighting related function a given direction. It should be noted that, as regards the aimed-boresighting function (for example a tracking boresighting), the latter is generally managed by the radar's global management facility and is manifested at the level of the method according to the invention by the taking into account of boresighting requests which define the characteristics of the tracking boresightings to be performed in the course of the rotation of the antenna (direction, waveform of associated suitable duration and degree of priority of the boresighting considered). On the contrary, as regards the surveillance function on the other hand, the latter is directly managed by the method according to the invention, in so far as the waveform implemented is generally determined and the directions boresighted are determined by the durations of the boresightings, the estimated instantaneous rotation speed of the antenna and by the radar load considered locally. Here, the expression radar load is understood to mean the number of boresightings to be executed in a given time interval.

Accordingly, the main function of the method according to the invention consists in determining, at given instant t, from among the set of requested boresightings, that having to be carried out at a given instant t′, in the near future, having regard to the predicted position of the antenna at this future instant t′. The future instant t′ considered is generally that which corresponds to the date of end of execution of the boresighting under execution at the instant t considered. To accomplish this task the method according to the invention comprises various processing modules which cooperate to take the following constraints into account in real time:
the necessity to take account of the authorized emission frequencies and their distribution in the frequency band allocated to the operation of the radar (this set of authorized frequencies consists of discrete frequencies which may be contiguous or disjoint. In the case of contiguous frequencies the set can be defined by the entire plan of the M available frequencies or by a sub-band of N frequencies. In the case of disjoint frequencies the authorized frequencies are defined by a comb of P non-adjacent frequencies, which may be limited to a single frequency).
the necessity to take account of the fact that each authorized frequency must be employed in an equiprobable manner (on average over the revolution and from revolution to revolution) and non-predictable manner (the choice of a frequency at an instant t cannot be predicted by the knowledge of a finite horizon of the played frequencies) so that certain types of jammings can be countered as well as possible.
the necessity to take account of the fact that the duration of the emitted waveform is variable from one boresighting to another.
the necessity to take account of a hierarchy in the importance of the requested boresightings, which is demarcated by a priority level accorded to each boresighting.
the necessity to take account of possible variations in the rotation speed of the antenna which condition the time interval during which this boresighting can be implemented.
the necessity to ensure that a reduced number of boresightings will not be executed;
the necessity to take account of the jammed frequencies in an instantaneous manner (by virtue of a listening time before the emission of each boresighting) by having the last steps of selecting the boresighting carried out by the antenna (dispatching of candidate frequencies/boresightings and selecting of the frequency according to the “Least Jammed Frequency” (LJF)).
the necessity to take account of the jammed frequencies from revolution to revolution as a function of the information of the map of the jammed frequencies which is kept and updated from revolution to revolution and per sector.
the desire to minimize the “dead times” (times of non-emission of boresightings) through the use in these cases of technical boresightings, the number of which depends on the current radar time budget.

Subsequently in this document the principle of the various functions implemented for taking these various constraints into account in the planning of the boresightings is described in more detail.

The method according to the invention, called “radar boresighting management” (RPM) finds its place in the control chain of the radar operating modes and is positioned between the module charged with the “radar task management” (RTM) and the module charged with the “radar pulse burst management” (RBM).

The radar task management (RTM) module provides the method according to the invention with information, in the form of requests for executing tasks, relating to the characteristics of certain boresightings or families of boresightings whose execution it requests, tracking boresightings mainly as well as certain particular surveillance boresightings (surveillance defined per sector). These characteristics are notably the direction of the boresighting, the nature of the waveform implemented, the renewal period of the boresightings (for periodic boresightings such as “tracking”) as well as the degree of priority associated with the execution of the boresighting considered.

The method according to the invention RPM takes these requests into account and incorporates them in useful time into a table that it keeps periodically as time passes. This table, or table of candidate boresightings, contains all the information relating to the boresightings that may be implemented during a given time interval, boresightings referred to here as “candidate boresightings”. The RPM method manages the ordering of the boresightings stored in the table by taking account of the position of the axis of the antenna, of the instantaneous antenna rotation speed and of the usable frequencies (i.e. the authorized and unjammed frequencies) by each boresighting and then delivers to the module charged with radar pulse burst management (RBM) the corresponding list of bursts to be emitted.

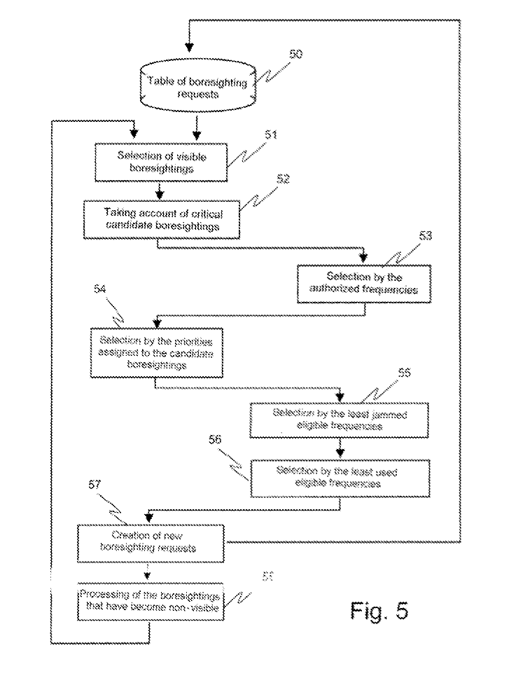

As illustrated by FIG. 5, the method according to the invention (RPM) is an iterative method consisting of eight successive steps 51 to 58. The two steps 52 and 54 are optional in nature while steps 51, 53, 55 to 58 constitute the essential steps of the method. Step 58 is for its part a final step which may be associated with the method and the object of which is to deal with the case of the boresightings which not having ultimately been selected that will no longer be visible at the following iteration, having regard to the nominal direction of the antenna.

The method according to the invention builds up and keeps up the table 50 of candidate boresightings, each candidate boresighting being initially associated, at each iteration, with one or more emission frequencies (an emission frequency possibly being associated with several candidate boresightings in this step), and then analyses in a regular manner the boresightings contained in the table so as to determine the order in which these candidate boresightings must be implemented. Stated otherwise, its object is to select at each iteration one of the candidate boresightings contained in the table 50 and one of the candidate frequencies initially associated with this boresighting. This (boresighting, frequency) pair is the first in terms of date to be implemented by the radar.

It should be noted that there is no bijection, in the table, between a boresighting and a frequency. A candidate boresighting can have several associated frequencies and conversely a candidate frequency can be associated with several candidate boresightings.

According to the invention the set of the emission frequencies associated with each boresighting is determined on the basis of a random draw carried out in the frequency plan globally allotted to the radar for its operation. In the preferred form of implementation of the invention this random draw is a particular draw, the main object of which is to ensure the diversity of the frequencies which will be ultimately played by the radar, all boresightings taken together. In this way, each candidate boresighting is associated, for a given iteration, with its own inherent set of frequencies, it being possible however, by chance, for two boresightings to be associated with one and the same set of frequencies which represents a subset of the frequency plan allotted to the radar. This subset is thus defined by a frequency fₘᵢₙ and a frequency fₘₐₓ.

To select a (boresighting, frequency) pair, each of steps 51 to 56 applies a processing which is specific to the candidate boresightings stored in the table and to the associated frequencies, the processing applied at each step making it possible to discard from the final selection (end of iteration) either one or more boresightings (steps 51, 52, 54 of the method) or one or more frequencies of the frequency plan allocated to the radar (steps 53, 55 and 56).

The processing implemented in a given step is applied either to the candidate boresightings retained, or to the candidate frequencies retained on completion of the previous steps.

The boresightings and the frequencies not discarded on completion of a given step are subjected to the selection of the following step, while the discarded boresightings are put aside for the remainder of the iteration so as possibly to be analysed again in the course of the following iteration.

Accordingly the (boresighting, frequency) pair ultimately retained on completion of the last step of the method is transmitted to the radar pulse burst management (RBM) module.

Subsequently in the document the set of the eight steps that the method according to the invention may comprise is described while bearing in mind that, steps 52 and 54 being optional, the method according to the invention may in a simplified version comprise only six steps.

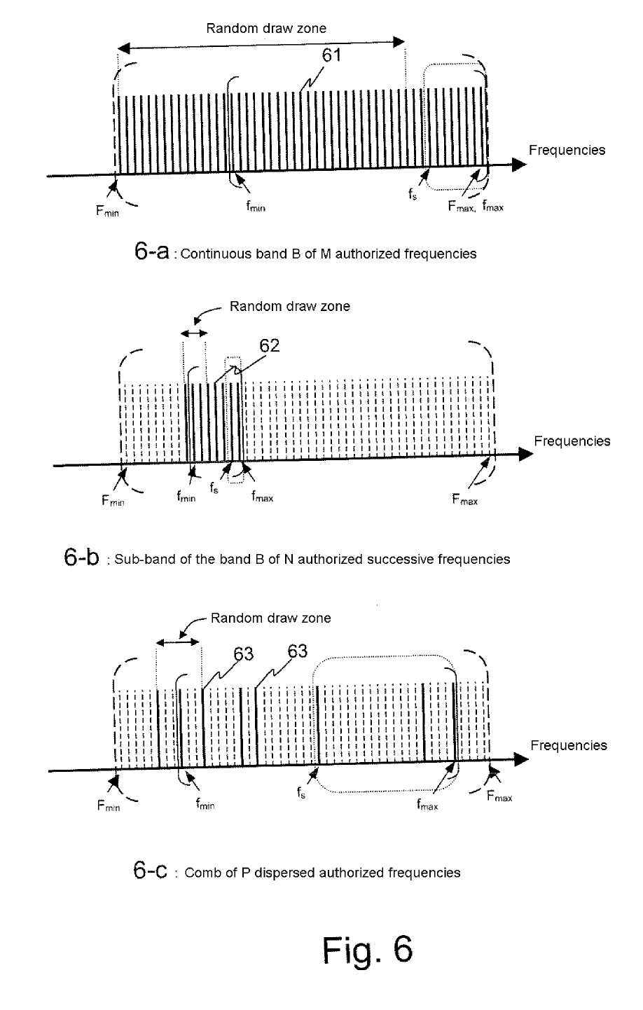

The first step 51 consists, as illustrated by FIGS. 6 and 8, in determining from among the candidate boresightings contained in the table, the boresightings 81, 82 whose managed visibility domain, which represents a fraction of the allocated visibility domain, does not contain the direction of the antenna at the instant considered. These boresightings are on principle discarded from the subsequent selection.

According to the invention, the table of the candidate boresightings in fact comprises for each boresighting at one and the same time the waveform characteristics associated with the boresighting, the priority level of the boresighting considered in relation to the other boresightings of the table, the requested direction θ₀ of the boresighting, the duration of the boresighting and the fraction of the visibility domain allocated to the boresighting.

According to the invention, the allocated visibility domain associated with a boresighting is defined as the azimuthal aperture accessible by deflection of the radar beam at the instant considered, having regard to the operating frequencies available (usable) for carrying out a boresighting in the direction considered. In an analogous manner the managed visibility domain associated with a boresighting is also defined as the azimuthal aperture accessible by deflection of the radar beam at the instant considered, having regard to the operating frequencies (candidate frequencies) associated by drawing with the boresighting considered in the table of the candidate boresightings, these frequencies being selected from the domain of the usable frequencies. Stated otherwise, the managed visibility domain constitutes an allocated fraction of the visibility domain. It is determined on the basis of the frequency span allocated to the boresighting considered. This frequency span itself represents a subset of the authorized frequency plan allocated to the radar.

The authorized frequency plan may take several forms, as illustrated by the illustrations 6-a to 6-c of FIG. 6. It may for example consist of a suite of M consecutive frequencies 61 covering the entire frequency plan B allocated to the operation of the radar (6-a) or a sub-band of N contiguous frequencies 62 (6-b) of the total frequency band B. It may also consist (6-c) of a suite of P frequencies 63 distributed disjointly or otherwise over the whole of the band B (called a sparse frequency comb). It will be noted here that the frequency band B allocated to the radar is very generally a set of regularly separated discrete frequencies lying between a frequency fₘᵢₙ and a frequency fₘₐₓ.

According to the invention, the frequency span allotted to each boresighting request, which frequencies form the managed visibility domain, is determined, as illustrated by the diagram of FIG. 6, by a minimum frequency fₘᵢₙ chosen with the aid of a random process from among the frequencies constituting the authorized frequency plan B which are less than a given frequency fₗᵢₘᵢₜ_{_{—}}_{draw}, and a maximum frequency fₘₐₓ greater than fₗᵢₘᵢₜ_{_{—}}_{draw} and less than or equal to the maximum frequency fₘₐₓ of this frequency plan. The set of n frequencies belonging to the interval [fₛ, fₘₐₓ] forms a zone of the managed visibility domain called the safety window. According to the invention n is defined as a small number relative to the number of authorized frequencies. The principle for determining fₘᵢₙ is set forth in the subsequent description relating to step 57.

Accordingly, step 51 selects the boresightings considered to be visible having regard to the criteria previously cited, the other candidate boresightings then being discarded.

It should furthermore be noted that, if certain candidate frequencies are associated only with candidate boresightings which are discarded, these frequencies are, as an immediate consequence, discarded from the choices made later during the iteration considered. Thus, the selection carried out in step 51, which step relates in principle only to the candidate boresightings, may in practice influence the selection of the frequencies.

According to the invention, the second step 52 is applied to the candidate boresightings which have not been rejected on completion of the first step 51. It consists, as illustrated by FIG. 9, in discarding the boresightings 82 which, if they were ultimately selected during the iteration considered, could induce the loss of one or more other candidate boresightings 81 whose deadline is close, that is to say boresightings 81 which, if they were discarded, could no longer be selected at the following iteration, having regard to the time required to emit the boresighting 82 retained at the iteration considered. This is in particular the case if, as illustrated by FIG. 9, the direction of the antenna lies at the instant of the selection close to the exit 93 of the managed visibility domain of the discarded boresighting (or boresightings). The principle of this second step therefore consists in taking into account the durations of execution 91 and 92 of the boresightings at issue 81 and 82 so as to determine whether the selection, made at the current iteration, of a candidate boresighting 82 may eliminate another candidate boresighting 81 at the following iteration, this boresighting, whose deadline is close, possibly being or not yet being a candidate boresighting at the moment of selection.

Accordingly on completion of the second step 52 the selected candidate boresightings are either the boresightings already selected in the course of step 51, or the boresightings judged to have priority in accordance with their deadline dates.

To deal with the case where several boresightings close to their deadline risk being lost, the method begins the tests iteratively with the one of highest priority. In case the boresighting remaining at this step is not playable in relation to its frequency, the previously deselected boresightings are reactivated.

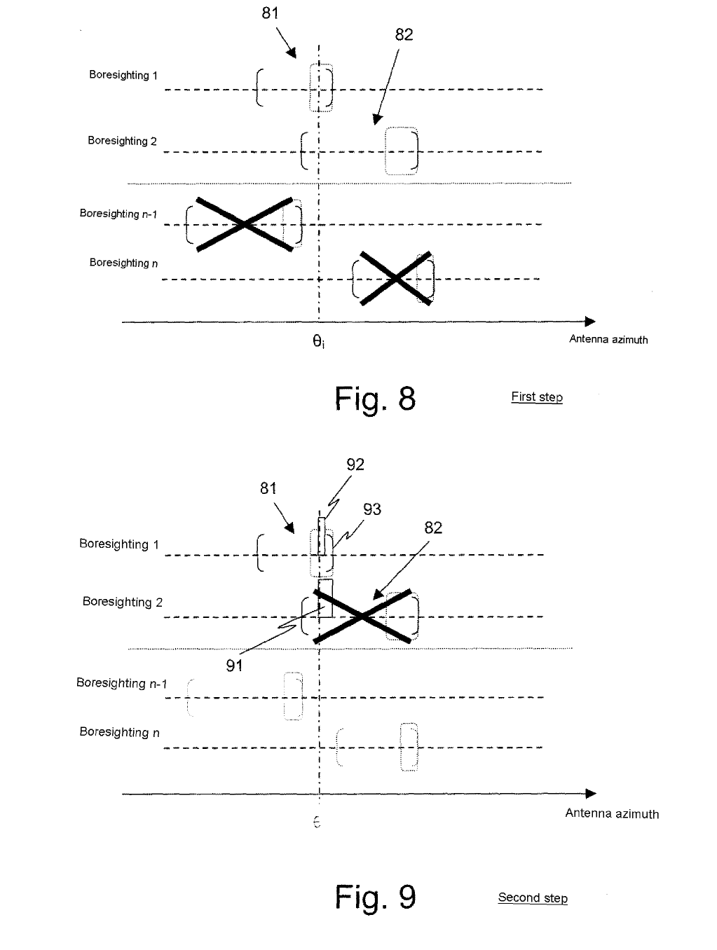

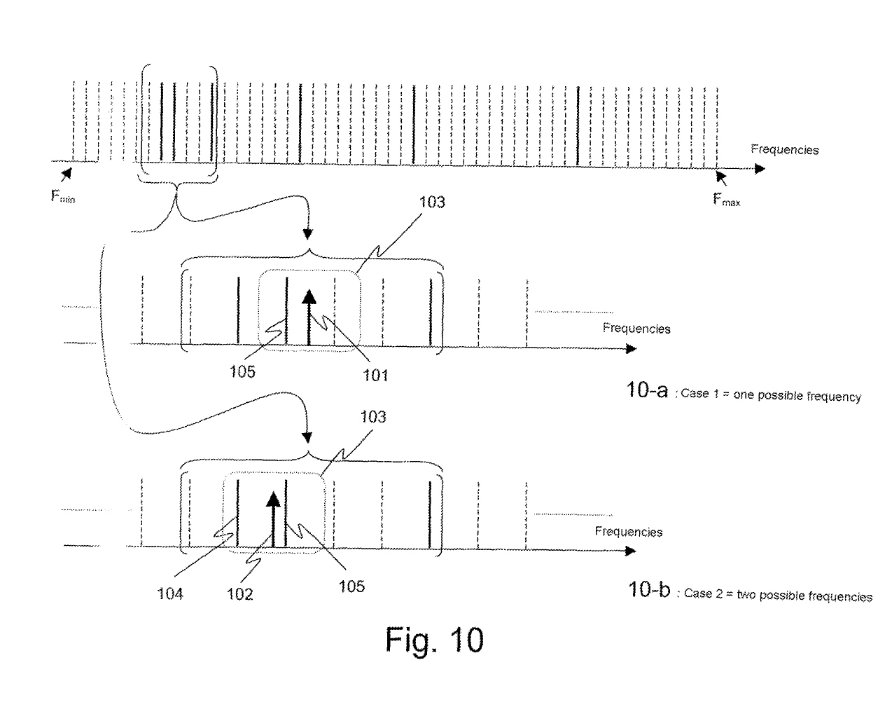

The object of the third step 53 of the method according to the invention is to select from among the boresightings retained on completion of the previous step, step 51 or 52 as the case may be, solely the boresightings for which one at least of the associated frequencies corresponds to the azimuthal deflection to be effected (with respect to the direction of the antenna) so as to execute this boresighting in the requested direction, these frequencies being the authorized frequencies corresponding to the managed visibility domain specific to each boresighting. The principle of this selection is illustrated by the illustrations 10-a and 10-b of FIG. 10 which illustrate two possible cases, the first case 10-a corresponding to a boresighting associated with two frequencies.

Accordingly, for each boresighting, the frequency or frequencies which are allocated to it which correspond at the instant of selection to the requested direction 101 or 102 (theoretical frequency) 101 of the boresighting having regard to a tolerance demarcated by the window 103 in the illustrations 10-a and 10-b of FIG. 10 is or are determined. The illustration 10-a presents the case where for a given boresighting, only one of the associated frequencies 105 can be retained. The illustration 10-b presents for its part the case where for a given boresighting, two of the associated frequencies 104 and 105 can be retained.

The tolerance demarcated by the window 103 makes it possible to limit the offset between the requested direction 101 or 102 and the direction actually boresighted 104 or 105 because the available frequencies are distributed in a discrete manner. The tolerance window is defined as a function of the radar's performance constraints.

Accordingly, if from among the candidate frequencies associated with the candidate boresighting considered, there exists at least one frequency in the neighbourhood of the frequency f₀ corresponding to the theoretical direction θ₀ of the boresighting, that is to say an allocated frequency lying in the tolerance window, then the boresighting is retained as well as the frequency or frequencies neighbouring f₀ which have enabled it to be retained.

Thus, under the assumption that none of the frequencies allocated to the candidate boresighting is situated in this window, said boresighting is discarded.

Likewise, under the assumption, corresponding to the illustration 10-a, that a single frequency 103 from among the allocated frequencies lies in this window, the boresighting and this frequency are retained.

Finally, under the assumption, corresponding to the illustration 10-b, that several of the frequencies 104 and 105 allocated lie in this window, the boresighting as well as these two frequencies are retained.

It is recalled here that, as illustrated by FIG. 10 and as has been stated previously, no bijective relation exists between a candidate boresighting and a candidate frequency (a candidate frequency 105 may be associated with several candidate boresightings, and conversely a candidate boresighting may possess several candidate frequencies 104, 105).

According to the invention the fourth step 54 of the method is applied to the candidate boresightings which have not been rejected on completion of the third step 53. It consists in taking into account the priority level allotted to each of the candidate boresightings. This priority level is notably dependent on the nature of the boresighting considered (for example different priorities may be allotted according to the importance of the type of boresighting, such as between surveillance and tracking boresightings) and the current position of the direction of the antenna in its managed visibility domain (a boresighting whose antenna direction enters its safeguard window sees its priority increase). On completion of this step, if a boresighting is of a higher priority level than the priority levels of the other boresightings retained on completion of the third step 53, this boresighting is preserved. Likewise, if several boresightings have an identical priority level, higher than the priority level of the other candidate boresightings retained on completion of the third step 53, these boresightings are preserved.

The object of the fifth step 55 of the method according to the invention is to discard from the final selection those of the candidate boresightings retained in the previous step, step 53 or 54 as the case may be, for which all the associated frequencies are declared jammed or, in the case where the frequencies associated with the candidate boresightings are all jammed, to discard all the candidate boresightings except for that or those associated with the least jammed frequency.

The determination of the jammed frequencies can be carried out in various known ways. It is for example possible to use a map of the jammed frequencies, established moreover by the radar during listening phases for example. This map is generally established for the whole of the radar's authorized frequency plan. This map is kept from revolution to revolution per sector as a function of the results of the frequencies listened to. Alternatively these jammed frequencies can also be determined in a dynamic manner, limiting the analysis of the jamming solely to the candidate frequencies, that is to say to the authorized frequencies actually accessible by the radar at the current instant, that is to say those which have been selected by the previous selection step 54. The analysis is then carried out by the radar in real time by undertaking, before the emission of a boresighting, listening targeted on a restricted suite of these few frequencies. The latter procedure is known as “Instantaneous Least Jammed Frequencies” (ILJF).

Accordingly the fifth step 55 of the method according to the invention distinguishes three cases:
if none of the candidate frequencies associated with the candidate boresightings retained is jammed none of the candidate boresightings is discarded.
if all the candidate frequencies are jammed, the boresighting preserved is that associated with the least jammed frequency.
if only certain candidate frequencies are jammed, only the candidate boresightings which are associated only with jammed frequencies are discarded.

It should be noted that for real-time operating constraints, step 55 and the following steps can be operationally inserted into the RBM, since the ILJF instantaneous listening method is very time-constrained.

According to the invention the sixth step 56 of the method is applied to the candidate boresightings which have not been rejected on completion of the fifth step 55. It constitutes the last selection step and consists in retaining only the candidate boresighting associated with the candidate frequency least used in the course of the previous iterations. This boresighting and the corresponding frequency form the (boresighting, frequency) pair ultimately selected.

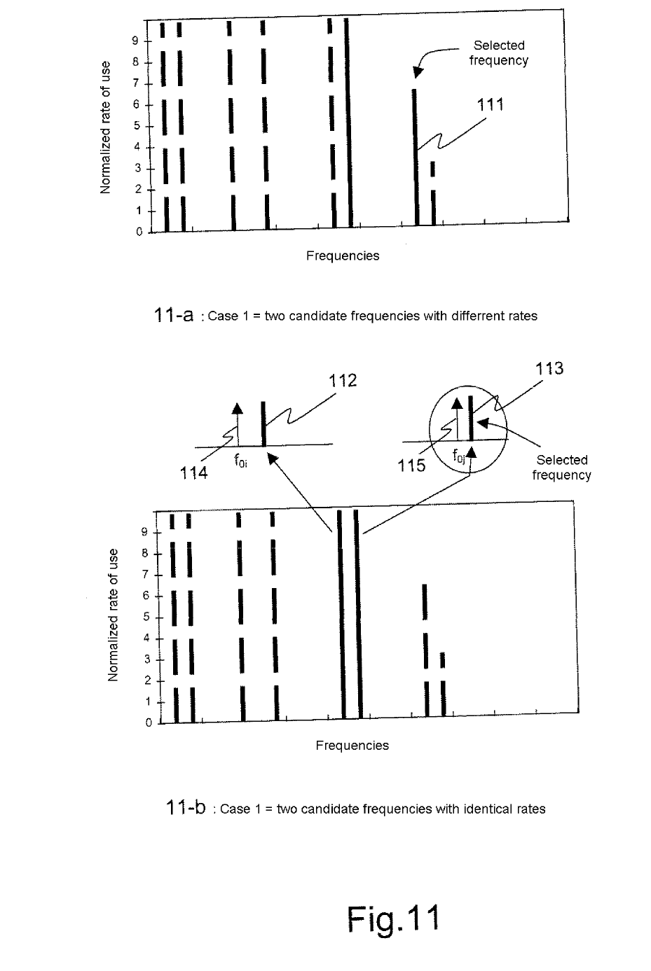

The test performed in the course of this sixth step, illustrated by FIG. 11, is based on the study of the histogram of the authorized frequencies emitted during the last antenna revolutions (for each authorized frequency percentage of boresightings emitted at this frequency). In the illustration of FIG. 11 the case is considered where only two candidate boresightings each associated with a single frequency are still retained (represented by solid straight line segments).

According to the invention, if a frequency 111, corresponding to the candidate boresightings retained on completion of the previous step, exhibits a lower rate of use than the other frequency retained (illustration 11-a, in continuous lines the candidate frequencies), this frequency is chosen. Accordingly the corresponding boresighting or boresightings are retained and the other candidate boresightings are discarded. On the other hand if all the frequencies corresponding to the boresightings retained exhibit an identical rate of use as shown by FIG. 11-b where two frequencies 112 and 113 have an equal rate of use, then the frequency chosen (113) is that which is the closest to the nominal frequency f₀ (114 for the frequency 112, 115 for the frequency 113) of the candidate boresighting with which it is associated. Accordingly the candidate boresighting with which this frequency is associated is retained and the other boresightings are discarded.

Lastly if several boresightings are associated with the frequency retained, that which will be retained is that for which the antenna direction is closest to the exit of its managed visibility domain, or what is equivalent, the boresighting whose temporal deadline is closest.

On completion of the sixth step 56 of the method according to the invention, a single candidate boresighting is ultimately retained. The characteristic waveforms of this boresighting are transmitted to the radar pulse burst management (RBM) which will thereafter produce the temporal sequencing of the radar emission phase and reception phase corresponding to this boresighting. The candidate boresighting is thereafter either deleted from the table of candidate boresightings (the case of surveillance boresightings), or maintained in memory in this table but in a deactivated form (the case of tracking boresightings, which are reactivated as a function of their emission period).

The sixth step of the method according to the invention is followed by a seventh step 57, the object of which is to supply the table of the candidate boresightings on the basis of new boresighting requests or to reactivate tracking boresighting requests which will soon be visible again by the antenna.

This step carries out in particular the choice of the span of the frequencies which are associated with each boresighting, which frequencies, as has been stated previously, are chosen by implementing a particular random draw. The main object of this random draw of the frequencies is to ensure the diversity of the frequencies which will ultimately be played by the radar, all boresightings taken together. It consists in determining the start-of-span and end-of-span frequencies fₘᵢₙ and fₘₐₓ.

The start-of-span frequency fₘᵢₙ is chosen in a random manner from among the frequencies of the span that are far enough away from the safety window as to ensure the satisfaction of the frequency diversity constraint. However, the determination of the frequency fₘᵢₙ, which characterizes the start of the frequency span allocated to the boresighting, does not result from a simple equiprobable random draw for which the probability of choosing, for fₘᵢₙ, a given frequency of the previously mentioned frequency plan is the same for all the frequencies of the zone of draw of the first frequency. It results in reality from a draw for which the probability of choosing, for fₘᵢₙ, a given frequency is a decreasing function of the relative position of this frequency in the zone of draw of the first frequency, the lowest frequencies having more chance of being chosen than the highest ones.

According to the invention, the law of decrease is established in such a way that the minimum frequency (fₘᵢₙ) is drawn while putting aside the highest frequencies of the frequency domain, frequencies below the maximum frequency fₘₐₓ A limit minimum frequency fₗᵢₘᵢₜ_{_{—}}_{draw} below the frequency F max is thus defined so that the zone of draw of the frequency fₘᵢₙ lies in the interval [Fₘᵢₙ, fₗᵢₘᵢₜ_{_{—}}_{draw}] The random draw zone [Fₘᵢₙ, fₗᵢₘᵢₜ_{_{—}}_{draw}] is such that the probability of drawing a frequency beyond fₗᵢₘᵢₜ_{_{—}}_{draw} is zero. The law for the probabilities of drawing in the interval [Fₘᵢₙ, fₗᵢₘᵢₜ_{_{—}}_{draw}] the minimum frequency fₘᵢₙ is furthermore decreasing, the effect of which is advantageously to compensate for the fact that the intersection of all the sets, which will ultimately be allotted to the boresightings, will favour the occurrence of selection of the high frequencies in these sets. The decreasing nature of the law for drawing fₘᵢₙ which favours the low frequencies will advantageously compensate for the induced effect of systematic favouring of the high frequencies, this effect being naturally caused by the mode of selection of the frequencies which is implemented in the course of the steps of the method according to the invention. It thus makes it possible to establish an equiprobability of the frequencies played by the radar. According to the invention, the formula for drawing the minimum frequency fₘᵢₙ is given by the expression:

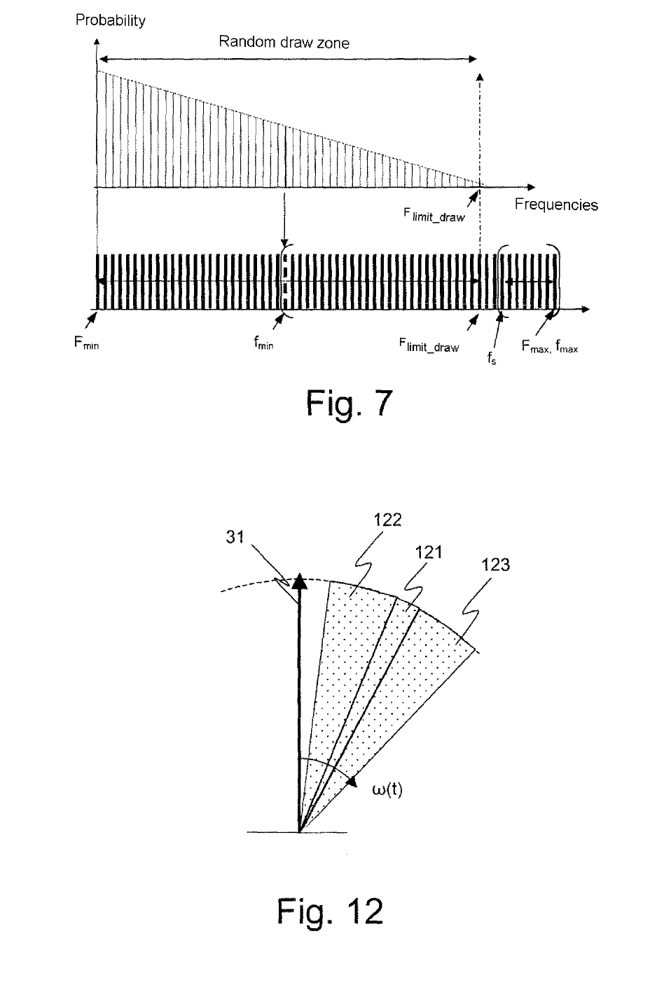

i_{freq}=Nb_{freq}_{_{—}}_{random}1E(Nb_{freq}_{_{—}}_{random}Draw_uniform(.)Coeff_draw) [2]

in which:
Nb_{freq}_{_{—}}_{random} is the number of frequencies of the span of the random draw;
E( ) is the function which returns the integer part of a number;
Draw_uniform(.) is the function which returns a number between 0 and 1 in accordance with a uniform law;
Coeff_draw is a real coefficient between 0 and 1, used as exponent in the function Draw_uniform(.). It will be possible to take, for example, a value equal to 0.5 and thus obtain a draw according to a law which follows a uniform decay (linear law) as in the case illustrated by FIG. 7. Alternatively, it will be possible to take, for example, a value equal to 0.25 and thus obtain a draw according to a law which follows a quadratic decay.
i_{freq} is the index of the selected frequency, the frequencies of the span of the random draw being indexed from 0 for the lowest frequency to (Nb_{freq}_{_{—}}_{random}−1) for the highest frequency. The frequency corresponding to the index i_{freq} will correspond to the frequency fₘᵢₙ of the window allotted to the boresighting.

As shown by simulations performed by the applicant, this particular random draw unlike an equiprobable random draw contributes to advantageously obtaining a homogeneous distribution in the course of time of the authorized frequencies. It thus contributes to the radar being less sensitive to certain types of jamming.

Thus, step 57 of the method according to the invention makes it possible to associate with each of the candidate boresightings, a frequency span whose start frequency, fₘᵢₙ, is determined so as to induce a more homogeneous distribution of the frequencies which will be implemented. These frequencies constitute the zone dubbed “zone of draw of the first frequency”. A given number of frequencies is in this way allotted to each candidate boresighting at the moment of its integration into the table. The determination of the frequency span associated with each candidate boresighting is advantageously carried out in a completely independent manner from one boresighting to another. Each frequency determines, having regard to the position of the antenna and its rotation speed, a possible instant at which the boresighting considered can be carried out. As illustrated by FIG. 7, the frequency span thus determined therefore makes it possible to define for each boresighting request an angular zone of variable (random) size called the managed visibility domain which when it is traversed by the antenna direction authorizes the radar to implement the corresponding boresighting by using one of the frequencies of the span. In this way, as illustrated by FIG. 8, it is possible to determine, for a given direction of the antenna, the candidate boresightings 81 and 82 that may be implemented at a given instant, as soon as the antenna azimuth lies in one at least of the visibility domains of the candidate boresightings.

Subsequently the boresighting requests which have been chosen and those whose implementation is no longer possible (antenna direction situated after the visibility domains of these requests) are eliminated from the table while the others remain there (antenna direction situated before or in the visibility domains of these requests) so as to be taken into account at the following iteration.

In addition to the choice of the span of the frequencies which are associated with each candidate boresighting, step 57 also has the function of dynamically constructing at each iteration, as illustrated by FIG. 12, the new boresighting requests to be taken into account. These new requests are at one and the same time new requests for surveillance boresightings whose directions are included in a first angular window 121 contiguous with the visibility domain 122 of the radar (complete visibility domain if all the frequencies are authorized or partial visibility domain if only some of the frequencies are authorized) as well as requests for boresightings of other types that may possibly arise, tracking requests for example, requests whose directions are included in a second angular window 123 contiguous with the first window 121. The position of the antenna 31 taken as origin is that obtained after taking the last chosen boresighting into account.

According to a preferred mode of implementation of the invention, the size of the first angular window 121 is determined so as to correspond to the angle of rotation of the antenna over a duration equivalent to the maximum duration of a half-boresighting, to which is added the maximum delay that can exist between the moment at which a boresighting has been selected and the moment at which it is actually emitted.

According to this preferred mode of implementation, the size of the second angular window 123 is for its part determined as being proportional to the azimuthal extension value DAz_{LoadAdaptation} which corresponds to a multiple of the azimuthal extension of the partial visibility domain within the limit of that of the complete visibility domain. This window can be for example equal to 0.5 times the azimuthal extension value DAz_{LoadAdaptation} The theoretical limit beyond which a local overload centered on this sector can no longer be dealt with, is for its part equal to twice the partial visibility.

In practice, to dynamically create a surveillance boresighting in a given direction, included in the first window 121, the method according to the invention takes into account the boresighting requests relating to boresightings other than surveillance boresightings whose direction is included in the second window 123 and the last surveillance boresighting created at the previous iteration. Accordingly the direction of the surveillance boresighting considered is the direction of the previous surveillance boresighting, to which is added an azimuthal offset OffsetAz_{Surv}, defined and calculated as follows.

The implementation of this logic for adapting the radar to the load is done by considering that the azimuthal offset imposed by the method according to the invention between two neighbouring surveillance boresightings, OffsetAz_{Surv}, comprises a long-term component, OffsetAz_{SurvLT}, and a short-term component,

OffsetAz_{SurvLT} is influenced very little by the local discrepancies in load. Its value corresponds to the azimuthal sector scanned by the antenna for the mean duration of a boresighting, duration calculated over a time period of several seconds, by taking account of a percentage of technical boresightings which is fixed a priori.

OffsetAz_{SuryST} reacts solely to the local load variations. Its value is given by the following expression:

OffsetAz_{SuryST}=DA_{Z}_{_{Load}}OffsetAZ_{-SurVLT}/DA_{ZAdaptationLoad}−DA_{Z}_{_{Load}}) [3]

In which DAzLoad corresponds to the noted instantaneous discrepancy in radar load, referred to a positive azimuthal value in the case of overload and a negative azimuthal value in the case of under-load.

It is noted that OffsetAz_{SurvST} is positive in the case of overload (the surveillance boresightings are discarded more for a certain time so that radar load is released progressively), negative in the case of under-load (the spacing between surveillance boresightings is tightened for a certain time so as to profit progressively from the surplus radar load available) and zero when the load is normal. In the case of significant and abrupt local overload, the maximum separation between boresightings by the method will be limited.

So that the azimuthal offset remains practically constant in the processed zone, the calculation of OffsetAz_{SurvST} is performed only in the case of detecting a new cause of overload or of under-load (such as for example when taking into account a tracking boresighting or a variation in the antenna rotation speed) or when the load state has reverted to normal. In the latter case, the azimuthal offset is considered to be given by the component OffsetAz_{SurvLT}.

The calculation of the azimuthal offset thus calculated makes it possible to contrive matters such that a state of radar overload or under-load is dealt with best in an azimuthal sector of width equal to DAz_{LoadAdaptation} this sector the azimuthal offsets between surveillance boresightings will be almost constant and entry and exit for this sector will happen without too abrupt a variation in these offsets, guaranteed in this regard by the sufficient width of the sector in question.

For each future surveillance boresighting, stored in the table of candidate boresightings, the corresponding boresighted direction is thus determined.

The seventh step 57 is finally followed by a last step 58 consisting in processing the candidate boresightings which have not been retained during the latest iterations and which are no longer possible candidates for the following iteration because the direction of the antenna has left their respective managed visibility domains; two cases have to be taken into account:
if the candidate boresighting is a surveillance boresighting it is purely and simply deleted from the table of candidate boresightings,
if the candidate boresighting is not a surveillance boresighting but it is however periodic (tracking boresighting for example) it is preserved in the table of candidate boresightings but the state deactivated (it is not taken into account in the selection steps) and it will be activated again and its parameters will then be updated (such as for example its position and its managed visibility domain) at the next antenna revolution or at its next period during the new pass through the angular window 123.

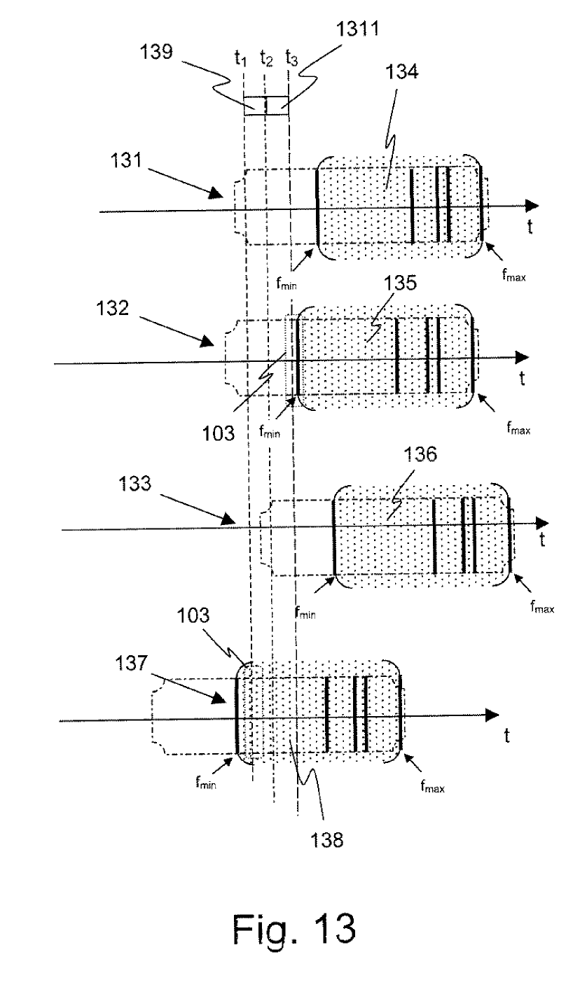

It should be noted that if, on completion of an iteration of the various steps of the method according to the invention, no boresighting is selected (detection of “dead times”), a technical boresighting is implemented (cf. FIG. 13). A new iteration is then instigated.

In the same manner, if the candidate boresightings are insufficient in number during the first step of a given iteration, a technical boresighting is selected. The processing of an insufficient number of candidate boresightings would not in fact allow efficient management of the frequencies, that is to say maintenance of the equiprobability of the frequencies. A new iteration is then instigated.

The principle of managing the “dead times” by inserting technical boresightings is illustrated in FIG. 13.

If at a given instant t₁, there is no active candidate boresighting, either because, having regard to the azimuth of the antenna, the visibility domains, 134, 135 or 136, of the available candidate boresightings 131, 132 or 133, is not accessible by the antenna beam at the instant t₁, or because the part of the visibility domain 138 of one or more available candidate boresightings 137 corresponding to the frequencies associated with these boresightings is not accessible by the antenna beam at the instant t (cf. FIG. 10 which shows examples of boresightings accessible by the antenna on account of the tolerance demarcated by the window 103), a technical boresighting 139 of a given duration, is inserted. The instant t₂ of end of execution of the technical boresighting is then determined and one looks to see whether at this instant, having regard to the rotation of the antenna, some of the previous candidate boresightings, 131, 132, 133 or 137, have become active.

If they have, then the active candidate boresightings are taken into consideration. If they have not, then no candidate boresighting yet being accessible, another technical boresighting 1311 is inserted.

The operation is repeated until for a given instant t3, having regard to the azimuth of the antenna at this instant, a first candidate boresighting 132 becomes, having regard to the direction of the antenna, potentially accessible. It should be noted that, according to the invention, the rate of technical boresightings is regulated via the function 57 (the offset between boresightings takes account of a percentage of time, defined a priori and fixed by the operator, for the technical boresightings).

By using the dispersive character of the antenna used by the radar in which it is implemented, the method according to the invention advantageously makes it possible, as regards the boresightings to be executed during the antenna rotation period, to substitute the concept of execution time interval for the concept of instant of execution. It thus makes it possible to manage the radar load in an optimal manner by determining the order of execution of the boresightings to be executed in a given time interval (that it has itself created), and makes it possible to insert aimed boresightings (such as tracking boresightings) making it possible to transform this radar into a multifunction radar.

It makes it possible to harmoniously manage the radar load variations (caused by the insertion of tracking boresightings and by the fluctuation of the antenna rotation speed) by virtue of an adaptation of the offsetting of the surveillance boresightings to these load variations.

It also makes it possible to effectively manage the frequencies, by playing in a random and homogeneous manner the authorized or the least jammed frequencies. In relation to the jamming, the method makes it possible to adapt to the jamming map kept from revolution to revolution and to the instantaneous listening for the least jammed frequencies, so as to best select the frequencies to be used.

The possibility of multifunction type operation is available by virtue of the capability to dynamically insert aimed boresightings of the “active tracking”, “Non-Cooperative Target Recognition (NCTR)”, “external designation”, etc. type; but also of advanced antijamming functions “Pick-A-Boo” (offsetting of boresightings around a jammed direction, so as to limit the effects of the jamming). For an NCTR boresighting capability with broadband waveforms (ramp-wise frequency modulation), and to avoid the off-boresighting of the beam with respect to the position of the target, the boresighting will be ordered by virtue of the method of the invention as several sub-boresightings of reduced frequency-ramps (principle of multi-ramp waveforms).

1.-9. (canceled)

10. A method for managing the emission of the boresightings by a radar comprising a rotating dispersive antenna whose rotation speed may vary in the course of time, the management being performed as a function of the visibility domain of the antenna at the instant considered, the method being applied in an iterative manner to candidate boresightings, each candidate boresighting being associated in a table with a set of candidate frequencies determined from among the set of authorized radar frequencies, the method comprises selecting, in each iteration, that of the candidate boresightings having to be executed first as well as the frequency associated with this boresighting for its execution, said method comprising:
a first step during which for the iteration considered candidate boresightings whose direction is not accessible by the antenna lobe having regard to the frequencies associated with them in the table and of the direction in which the antenna is directed are eliminated;
a second step during which for each of the remaining boresightings those of the associated candidate frequencies which are not situated in a given neighbourhood of the theoretical frequency making it possible to execute the boresighting considered in the desired direction, having regard to the direction in which the antenna is directed, are eliminated;
a third step during which it is determined whether some of the remaining frequencies are jammed and in the case where all the remaining frequencies are jammed, it is determined which of the frequencies is the least jammed; the jammed frequencies being eliminated with the exception of the least jammed frequency;
a fourth step during which the least used frequency is selected from among the remaining candidate frequencies; the remaining candidate boresightings which are not associated with this frequency being eliminated;
the non-eliminated candidate boresighting with which is associated the least used candidate frequency being transmitted to the means charged with implementing the corresponding waveforms;
a fifth step of creating new boresighting requests; each new boresighting request consisting of a new candidate boresighting or a candidate boresighting that has not yet been executed and a set of associated candidate frequencies, these frequencies being those of the authorized frequencies which are contained in a frequency band determined in a random manner in the frequency band B allocated to the radar;
a final step of treating the case of the boresightings which are no longer visible on completion of the current iteration having regard to the displacement of the visibility domain subsequent to the rotation of the antenna;
the steps of the forming method being repeated in an iterative manner, the table which associates the candidate boresightings and the candidate frequencies being renewed at each cycle.

11. The method according to claim 10, further comprising an intermediate step between the first and second step, which comprises eliminating the candidate boresightings which, if they were ultimately selected during the iteration considered, could induce the loss of one or more other candidate boresightings whose duration of visibility is short.

12. The method according to claim 11 further comprising a second intermediate step, between the second and third step, for performing the selections of the boresightings declared as having the highest priority.

13. The method claim 10, wherein the step of creating new boresighting requests undertakes for each candidate boresighting the association of a frequency span included in an interval bounded by two frequencies fₘᵢₙ and fₘₐₓ, frequency fₘₐₓ being the highest frequency of the domain of authorized frequencies, and frequency fₘᵢₙ being a frequency chosen in a random manner in a frequency domain extending from the lowest frequency of the domain of authorized frequencies to a frequency fₗᵢₘᵢₜ_{_{—}}_{draw} greater than fₘᵢₙ and less than fₘₐₓ.

14. The method according to claim 13, wherein frequency fₘᵢₙ is obtained by a random draw with a probability density which decreases as the frequency increases.

15. The method according to claim 13, wherein frequency fₗᵢₘᵢₜ_{_{—}}_{draw} is determined so as to define with fₘₐₓ an interval of frequencies containing a number n of authorized frequencies that is small relative to the number of authorized frequencies contained in the interval limited by fₘᵢₙ and fₘₐₓ.

16. The method according to claim 14, wherein frequency fₗᵢₘᵢₜ_{_{—}}_{draw} is determined so as to define with fₘₐₓ an interval of frequencies containing a number n of authorized frequencies that is small relative to the number of authorized frequencies contained in the interval limited by fₘᵢₙ and fₘₐₓ.

17. The method according to claim 10, wherein for the determination of the new candidate boresightings, the fifth step of creating new boresighting requests takes into account a first angular window contiguous with the visibility domain for the determination of the new surveillance boresightings and a second angular window contiguous with the first window for the determination of the other new boresightings, the first and second angular windows being determined so as to take into account the rotation of the antenna.

18. The method according to claim 17, wherein the first angular window is determined so as to correspond to the angle of rotation of the antenna over a duration equivalent to the maximum duration of a half-boresighting, to which is added the maximum delay that can exist between the moment at which a boresighting has been selected and the moment at which it is actually emitted; the size of the second angular window being for its part defined as being proportional to the azimuthal extension value DAz_{LoadAdaptation} which corresponds to a multiple of the azimuthal extension corresponding to the partial visibility domain, DAz_{LoadAdaptation} being in all cases less than the complete visibility domain.

19. The method according to claim 10, wherein the third step takes into account the information relating to the least jammed frequencies for the selection of the boresightings in two possible ways, either locally by instantaneous listening to the jammed frequencies or globally by the use of the maps of jammed frequencies available.
